(19) United States
(12) Patent Application Publication
(10) Pub. No.: US 2026/0352917 A1
(43) Pub. Date: Nov. 5, 2026

(54) MEDIA FILE PRELOADING METHOD AND APPARATUS, ELECTRONIC DEVICE AND STORAGE MEDIUM

(71) Applicants: Douyin Vision Co., Ltd., Beijing (CN); BEIJING YOUZHUJU NETWORK TECHNOLOGY CO., LTD., Beijing (CN)

(72) Inventors: Jin WU, Beijing (CN); Zhendong ZHONG, Beijing (CN); Jiangnan LIU, Beijing (CN); Weicheng LU, Beijing (CN); Wenyi YAN, Beijing (CN); Haiqing TAO, Beijing (CN); Kunzhi GUI, Beijing (CN); Qian MA, Beijing (CN)

(21) Appl. No.: 19/487,451

(22) PCT Filed: May 28, 2024
(86) PCT No.: PCT/CN2024/095764

§ 371 Date: Nov. 24, 2025

(30) Foreign Application Priority Data
May 29, 2023 (CN) 202310622661.7

(51) Int. Cl. H04N 21/433; H04N 21/435; H04N 21/437; H04N 21/442

(52) U.S. Cl. CPC H04N 21/433; H04N 21/435; H04N 21/437; H04N 21/44209

(57) ABSTRACT

The present disclosure relates to a media file preloading method and apparatus, an electronic device, and a storage medium. The method is applied to a media player and comprises: obtaining media information of a media file to be played back, wherein the media information comprises a playback address and a file header size of said media file; creating a preloading task of said media file on the basis of the file header size, wherein the preloading task carries a preloading policy, and the preloading policy is used for indicating the preloading size of preloading said media file; and obtaining a file offset of said media file on the basis of the playback address, and preloading said media file on the basis of the preloading size and the file offset.

### CROSS-REFERENCE TO RELATED APPLICATIONS

The present application is based on and claims priority of the Chinese Patent Application No. 202310622661.7 titled “MEDIA FILE PRELOADING METHOD AND APPARATUS, ELECTRONIC DEVICE AND STORAGE MEDIUM” and filed on May 29, 2023, the disclosure of which is incorporated herein by reference in its entirety.

### TECHNICAL FIELD

The present disclosure relates to the field of media play technology, in particular to a media file preloading method and apparatus, an electronic device and a computer-readable storage medium.

### BACKGROUND

With the rapid development of Internet technology and multimedia technology, various multimedia applications have emerged. At present, during the process of playing a media file, in order to ensure that the user may start to play quickly without problems such as lagging and buffering, media data from the beginning for several seconds may usually be preloaded based on a playing behavior of the user.

### SUMMARY

An embodiment of the present disclosure provides a media file preloading method and apparatus, an electronic device and a computer-readable storage medium, so as to solve the problems present in the related art.

In a first aspect of the embodiment of the present disclosure, a media file preloading method applied to a media player is provided, the method comprising: obtaining media information of a media file to be played, wherein the media information comprises a playback address and a file header size of the media file to be played; creating a preloading task of the media file to be played based on the file header size, wherein the preloading task carries a preloading policy for indicating a preloading size of the preloaded media file to be played; obtaining a file offset of the media file to be played based on the playback address, and preloading the media file to be played based on the preloading size and the file offset.

In a second aspect of the embodiment of the present disclosure, a media file preloading device applied to a media player is provided, the device comprising: an obtaining module configured to obtain media information of a media file to be played, wherein the media information comprises a playback address and a file header size of the media file to be played; a creating module configured to create a preloading task of the media file to be played based on the file header size, wherein the preloading task carries a preloading policy for indicating a preloading size of the preloaded media file to be played; and a preloading module configured to obtain a file offset of the media file to be played based on the playback address, and preload the media file to be played based on the preloading size and the file offset.

In a third aspect of the embodiment of the present disclosure, an electronic device is provided, the electronic device comprising: at least one processor; a memory for storing instructions executable by the at least one processor; wherein at least one processor is used for executing instructions to realize the steps of the above-described method.

In a fourth aspect of the embodiment of the present disclosure, a computer-readable storage medium is provided, wherein an electronic device is enabled to perform the steps of the above-described method when instructions in the computer-readable storage medium are executed by a processor of the electronic device.

### BRIEF DESCRIPTION OF THE DRAWINGS

In order to more explicitly explain the technical solutions in the embodiments of the present disclosure, the accompanying drawings required to be used in the description of the embodiments or the related art will be briefly introduced below; obviously, the accompanying drawings described below are merely some of the embodiments of the present disclosure, and for those of ordinary skill in the art, other accompanying drawings may also be obtained according to these accompanying drawings on the premise that no inventive effort is involved.

FIG. 1 is a flowchart of a media file preloading method provided by one exemplary embodiment of the present disclosure.

FIG. 2 is a flowchart of another media file preloading method provided by one exemplary embodiment of the present disclosure.

FIG. 3 is a flowchart of still another media file preloading method provided by one exemplary embodiment of the present disclosure.

FIG. 4 is a schematic structural view of a media file preloading device provided by one exemplary embodiment of the present disclosure.

FIG. 5 is a schematic structural view of an electronic device provided by one exemplary embodiment of the present disclosure.

FIG. 6 is a structural view of a computer system provided by one exemplary embodiment of the present disclosure.

### DETAILED DESCRIPTION

The embodiments of the present disclosure will be described in more detail with reference to the accompanying drawings below. Although the accompanying drawings illustrate some embodiments of the present disclosure, it should be understood that the present disclosure may be implemented in various forms, and should not be construed as being limited to the embodiments set forth herein; rather, these embodiments are intended for a more thorough and complete understanding of the present disclosure. It should be understood that, the accompanying drawings and embodiments of the present disclosure are only for exemplary purposes, rather than for limiting the protection scope of the present disclosure.

It should be understood that the various steps recited in the method embodiments of the present disclosure may be performed according to different sequences, and/or performed in parallel. In addition, the method embodiments may include additional steps and/or omit to perform the illustrated steps. The scope of the present disclosure is not limited in this respect.

As used herein, the term “including” and its variants are open-ended inclusion, that is, “including but not limited to”. The term “based on” means “at least partially based on”. The term “one embodiment” means “at least one embodiment”; the term “another embodiment” means “at least one additional embodiment”; and the term “some embodiments” means “at least some embodiments”. The related definitions of other terms will be given in the following description. It is to be noted that, the concepts such as “first” and “second” mentioned in the present disclosure are only used to distinguish different devices, modules or units, but not to limit the order or interdependence of functions performed by these devices, modules or units.

It is to be noted that, the modifications of “one” and “a plurality of” mentioned in the present disclosure are illustrative rather than restrictive, and those skilled in the art should understand that they should be construed as “one or more” unless specified in the context otherwise.

The names of messages or information exchanged between multiple devices in the embodiments of the present disclosure are only used for illustrative purposes, but not for limiting the scope of these messages or information.

During the process of playing a media file, in order to ensure that the user may start to play quickly without problems such as lagging and buffering, media data from the beginning for several seconds may usually be preloaded based on a playing behavior of the user. However, in certain circumstances, the user may not want to play a media file from the zero second, therefore, the existing preloading method cannot ensure that enough media data may be preloaded when the user starting to play a media file at any time, which results in less flexibility in playing the media file and further affects the user experience.

In addition, since the size of the file header as well as a corresponding relationship between the start-to-play time and the file offset cannot be known before decoding the media file so that the preloading size of the media file cannot be accurately determined, the media data from the file header to the start-to-play time is usually preloaded. However, this part of media data may not be played by the user, which causes a waste of performance and unnecessary consumption of traffic.

In view of this, the embodiment of the present disclosure provides a media file preloading method and apparatus, an electronic device and a computer-readable storage medium, so as to solve the problems present in the related art. At least one technical solution used by the embodiment of the present disclosure can achieve the following beneficial effects: it is possible to ensure that enough media data may be preloaded when the user starting to play a media file at any time, thereby improving the flexibility in playing the media file, avoiding a waste of performance and unnecessary consumption of traffic, and enhancing the user experience, by: obtaining media information of the media file to be played, wherein the media information includes a playback address and a file header size of the media file to be played; creating a preloading task of the media file to be played based on the file header size, wherein the preloading task carries a preloading policy for indicating a preloading size of the preloaded media file to be played; obtaining a file offset of the media file to be played based on the playback address, and preloading the media file to be played based on the preloading size and the file offset.

A media file preloading method and apparatus of an embodiment according to the present disclosure will be explained in detail below in conjunction with the accompanying drawings.

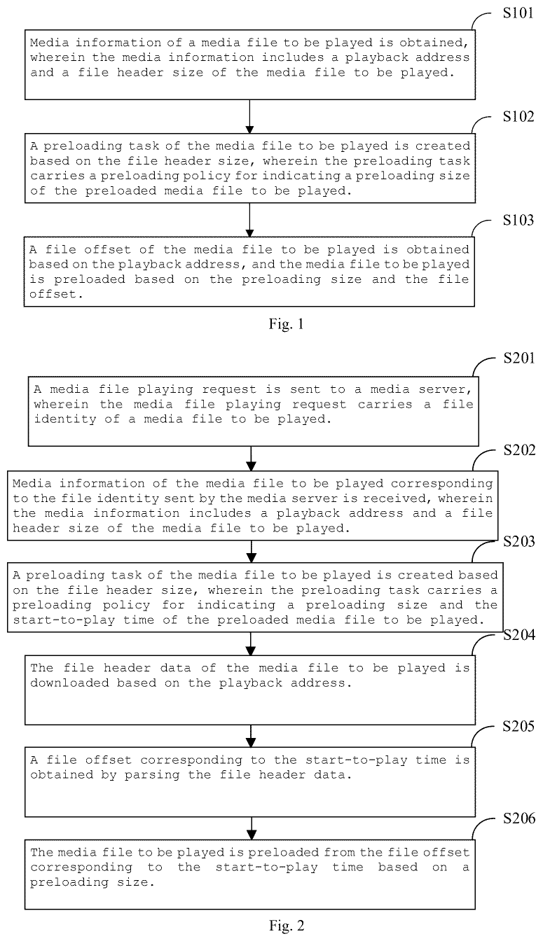

FIG. 1 is a flowchart of a media file preloading method provided by one exemplary embodiment of the present disclosure. The media file preloading method of FIG. 1 may be performed by a media player. As shown in FIG. 1, the media file preloading method comprises:
In S101, media information of a media file to be played is obtained, wherein the media information includes a playback address and a file header size of the media file to be played;
In S102, a preloading task of the media file to be played is created based on the file header size, wherein the preloading task carries a preloading policy for indicating a preloading size of the preloaded media file to be played;
In S103, a file offset of the media file to be played is obtained based on the playback address, and the media file to be played is preloaded based on the preloading size and the file offset.

Specifically, after obtaining media information of the media file to be played, the media player may create a preloading task of the media file to be played based on the file header size of the media file to be played included in the media information, and the preloading task carries a preloading policy for indicating a preloading size of the preloaded media file to be played; further, the media player obtains a file offset of the media file to be played based on the playback address, and preload the media file to be played based on the preloading size and the file offset.

Here, the media file refers to a file that stores encoded media data (for example, at least one of audio data or video data) in the form of a box, and also includes metadata (that is, data describing the media data) therein, which carries media information to ensure that the media data is correctly decoded.

The box, also referred to as a container, is an object-oriented member defined by a unique type identifier and length, which includes a box header and box data, and is filled with binary data to express various information therein. The container header includes a size and a type, wherein the size is used to represent the size of the storage space occupied by the box (also referred to as the size or length in the present disclosure), and the type is used to represent the type of the box. The box data part may store specific data, and may also further encapsulate other types of boxes.

Taking a media file which is a Moving Picture Experts Group 4 (MP4) file as an example, the basic box types involved in the MP4 file include file type box (ftyp box), metadata box (moov box) and media data box (mdat box). The file type box refers to the box for storing the capacity (that is, the length of bytes occupied) and type of the file in the media file. The metadata box refers to a box for storing metadata (that is, data describing the media data stored in a media data box) in a media file, and information expressed by binary data stored in the metadata box in the MP4 file is referred to as media information. The media data box refers to a box for storing media data in a media file.

In practical application, the media information may include information such as offset, capacity, index and timestamp of a video frame and/or an audio frame in a media file, and may also include information such as a playback address, a playing sequence, a playing position and a playing progress of a media file, which is not limited by the embodiment of the present disclosure.

The file header is located at the head of the media file for describing information such as the size (i.e. capacity) and type of the media file itself, so that the application program parses and opens the media file. It is to be noted that, the header size of the MP4 file is positively related to the duration of the media file, that is, the longer the duration of the media file is, the larger the file header will be; the shorter the duration of the media file is, the smaller the file header will be.

The media file to be played may be an Internet video file, such as a movie, a TV series, a sports program and a variety show on a video website; and may also be a music file, such as free music and paid music on a music website; alternatively, it may also be other types of files that may be played in the media player, which are not limited by the embodiment of the present disclosure. Further, the media file to be played may use a non-streaming media format. The non-streaming media format is an encapsulation technology that encapsulates media data into a media file which has to be completely downloaded so as to be decoded and played. The file with a non-streaming media format may include, but is not limited to, an MP4 file, an MKV file format, a Windows Media Video (WMV) file, an Advanced Streaming Format (ASF) file and the like. The streaming media format is to encapsulate media data into a streaming media file which does not have to be completely downloaded or need to be additionally transcoded so as to be decoded and played, that is, an encapsulation technology natively supporting to play while downloading. The file with a streaming media format may include, but is not limited to, a TS media file segment based on HTTP Live Streaming (HLS) technology, a FLV(Flash Video) file and the like.

It is to be noted that, the MP4 file does not natively support to play in the form of streaming, but can also realize the technical effect of playing while downloading by filling invalid binary data in the media stream transcoded to the player after online transcoding, or in a missing part of the MP4 file that is partially downloaded (for example, in the case where ftyp box and moov box are completely downloaded, the missing part of mdat box is filled with invalid binary data instead); in the present disclosure, the encapsulation format of this file that does not natively support to play in streaming is referred to as a non-streaming media format.

The media player refers to software that plays a video or audio file stored in the form of digital signals, or a device with the function of playing a video or audio file. In the embodiment of the present disclosure, the media player is an electronic device used by the user capable of playing an audio and/or video file, which may include but is not limited to a smart phone, a tablet computer, a notebook computer, a desktop computer, a Personal Digital Assistant (PDA), a smart TV, a smart watch, smart glasses, a smart bracelet and the like.

Preloading refers to downloading a certain length of media file in advance, and it is possible to start to play the media file directly without waiting for network loading when the user clicks on the media file to play. The preloading task is used to load a subsequent media file and carries a preloading policy, which may be used to limit the preloading size of the media file to be played. Generally, if there is less preload, it is impossible to achieve the effect of opening within a second (opening within a second means that a played frame may be seen within a second after clicking to play); if there is more preload, it is a waste of bandwidth, therefore, the preloading size may be set according to actual needs. For example, the preloading size may be any value ranging from 500 kilobytes (KB) to 1 megabyte (MB). Preferably, in the embodiment of the present disclosure, the preloading size is 800KB.

The file offset refers to the number of bytes moved forward or backward from a specified position, for finding a position of the data in use from the file. Generally, the offset may include three circumstances: the first is to move backward several bytes from the file header to find a target, the second is to move forward several bytes from the file trailer to find a target, and the third is to move forward or backward from a current position of the file to find a target. In the embodiment of the present disclosure, all the file offsets are the first file offset, that is, from the file header to the position where data is required.

According to the technical solution provided by the embodiment of the disclosure, it is possible to ensure that enough media data may be preloaded when the user starting to play a media file at any time, thereby improving the flexibility in playing the media file, avoiding a waste of performance and unnecessary consumption of traffic, and enhancing the user experience, by: obtaining media information of the media file to be played, wherein the media information includes a playback address and a file header size of the media file to be played; creating a preloading task of the media file to be played based on the file header size, wherein the preloading task carries a preloading policy for indicating a preloading size of the preloaded media file to be played; obtaining a file offset of the media file to be played based on the playback address, and preloading the media file to be played based on the preloading size and the file offset.

In some embodiments, the obtaining media information of a media file to be played includes: sending a media file playing request to the media server, wherein the media file playing request carries a file identity of the media file to be played; and receiving media information of the media file to be played corresponding to the file identity sent by the media server.

Specifically, the media player is integrated with a media playing component corresponding to the media server, that is, a Software Development Kit (SDK), which may serve as a bridge for communication between the media player and the media server and be used for playing a media file obtained from a Content Delivery Network (CDN). After successfully logging on the media server by logging on the account, the media player may send a media file playing request carrying a file identity of the media file to be played to the media server, so that the media server may send media information of the media file to be played corresponding to the file identity found from the media database or the content delivery network to the media player after receiving the media file playing request.

Here, the media server refers to a server that may provide a plurality of media services for the media playing application in the media player, wherein the plurality of media services may include but not are limited to a data storage service, a sending and receiving service of interactive information and the like. The data storage service refers to the service of storing various data (for example, multimedia data, interactive information and the like), and the sending and receiving service of interactive information refers to the service of receiving interactive information and sending interactive information to the media playing application.

The media server may be an independent physical server, and may also be a server cluster or a distributed system composed of multiple physical servers; alternatively, the media server may be a cloud server that provides basic cloud computing services such as cloud service, cloud database, cloud computing, cloud function, cloud storage, network service, cloud communication, middleware service, domain name service, security service, content delivery network, big data and artificial intelligence platform, which are not limited by the embodiment of the present disclosure.

The media file playing request is used to apply to the media server to play the media file to be played, and includes a file identity (ID) of the media file to be played. The file identity is a unique identity for representing a media file, including but not limited to a letter, a number, a symbol and the like.

According to the technical solution provided by the embodiment of the present disclosure, the file header size of the media file to be played may be obtained from the received media information, and the preloading task of the media file to be played may be created based on the file header size, thereby avoiding a waste of performance and unnecessary consumption of traffic.

In some embodiments, the preloading policy is also used to indicate the start-to-play time of preloading the media file to be played, and the obtaining a file offset of the media file to be played based on the playback address includes: downloading the file header data of the media file to be played based on the playback address; and parsing the file header data to obtain the file offset corresponding to the start-to-play time.

Specifically, the preloading policy may be used to limit the start-to-play time of the media file to be played, for example, when a media file playing request is sent to the media server, the user may specify to start to play from any time of the media file to be played through the media player; further, after successfully downloading the file header data of the media file to be played based on the obtained playback address, the CDN server parses the file header data, and locates to an initial file offset of a key frame in mdat corresponding to this time by parsing an index of the key frame (that is, audio and video frame) in metadata encapsulated in the moov box.

Here, the key frame refers to the frame in which the key action in the motion or change of a character or object is located. When the media file to be played is decoded, the media server may obtain I-frames, which are also referred to as intra-frame coding frames, which are independent frames built-in with all the information and may be decoded independently without referring to other images; on such basis, the media server may determine the I-frames obtained by decoding as key frames to form a key frame sequence of the media file to be played. In the embodiment of the present disclosure, one key frame may be set per 5000 ms. For example, the start-to-play time of the key frame 0 is 0 ms, and the corresponding file offset is 0; the start-to-play time of the key frame 1 is 0 ms, and the corresponding file offset is 322852; the start-to-play time of the key frame 2 is 5000 ms, and the corresponding file offset is 2548831; the start-to-play time of the key frame 3 is 10000 ms, and the corresponding file offset is 4885774.

Alternatively, when the media player lags, the playing process may be first suspended to stop data consumption; at the same time, wait for the download thread to load more data into the buffer before starting to play, so as to reduce the probability of subsequent lagging. Here, the pause duration may be determined by designing a more detailed preloading policy, which is related to the goal, that is, whether it is more important to reduce the number of lags or to reduce the duration of lags.

For example, a three-tier preloading policy may be designed, that is, the first-tier preloading policy, the second-tier preloading policy and the third-tier preloading policy, and the buffer duration of the three-tier preloading policy may be set to be 500 ms, 1000 ms and 5000 ms respectively. The first-tier preloading policy refers to how much media data the media player loads for the first time before starting to play; in order to accelerate the start-to-play for the first time, this value is usually set to be very low, for example, 500 ms as described above. The second-tier preloading policy refers to how much media data the media player has to load before starting to play after lag occurs once, for example, 1000 ms as described above. The third-tier preloading policy refers to how much media data that the media player loads at most before starting to play after lag occurs, for example, 5000 ms as described above.

Further, there may be a gradually upgrading policy between the second-tier preloading policy and the third-tier preloading policy. For example, after the first lag, the media data of 1000 ms is buffered before starting to play; after the second lag, the media data of 2×1000 ms=2000 ms is buffered before starting to play; after the third lag, the media data of 2×2000 ms=4000 ms is buffered before starting to play; after the fourth lag, the media data of min(2×4000 ms=8000 ms, 5000 ms)=5000 ms is buffered before starting to play; for subsequent lags, the media data of 5000 ms is buffered before starting to play.

According to the technical solution provided by the embodiment of the present disclosure, the preloaded media data may be determined based on the file offset corresponding to the start-to-play time, thereby avoiding unnecessary waste of traffic caused by excessive preloaded multimedia data.

In some embodiments, the preloading the media file to be played based on the preloading size and the file offset includes: preloading the media file to be played from the file offset corresponding to the start-to-play time based on the preloading size.

Specifically, after locating the file offset corresponding to the start-to-play time, the media player may preload the media file to be played from the file offset corresponding to the start-to-play time based on the preloading size, so as to ensure that enough media data may be preloaded when the user starting to play the media file at any time and improve the flexibility in playing the media file, thereby avoiding the situation that the user waits too long, and further enhancing the user experience.

For example, suppose that the start-to-play time of the key frame 1 is 0 ms, and the corresponding file offset is 322852; the start-to-play time of the key frame 2 is 5000 ms, and the corresponding file offset is 2548831; the start-to-play time of the key frame 3 is 10000 ms, and the corresponding file offset is 4885774; if the start-to-play time specified by the user is 5 seconds (equivalent to 5000 ms), the media file to be played will be preloaded from the position with the file offset of 2548831 corresponding to 5000 ms.

In some embodiments, based on the preloading size, the preloading the media file to be played from the file offset corresponding to the start-to-play time includes: preloading the media file to be played from the file offset corresponding to the first time based on the preloading size in the case where the start-to-play time is between the first time and the second time, wherein the first time is earlier than the second time.

Specifically, when the start-to-play time is between the first time and the second time, the media player may preload the media file to be played from the file offset corresponding to the first time based on the preloading size. Here, neither the first time nor the second time starts to play the media file, and the first time is earlier than the second time.

Still for example, the start-to-play time of the key frame 1 is 0 ms, and the corresponding file offset is 322852; the start-to-play time of the key frame 2 is 5000 ms, and the corresponding file offset is 2548831; the start-to-play time of the key frame 3 is 10000 ms and the corresponding file offset is 4885774. Assuming that the start-to-play time specified by the user is 8 seconds (equivalent to 8000 ms), which is between 5000 ms and 10000 ms, if the media file to be played is preloaded from the position with the file offset of 4885774 corresponding to 10000 ms, the media file to be played between 8000 ms and 10000 ms will not be preloaded, so that the user cannot see the file content corresponding to this part of the media file to be played; therefore, in order to ensure that the user can see the complete file content, the media file to be played is still preloaded from the position with the file offset of 2548831 corresponding to 5000 ms.

In some embodiments, the method further includes: detecting a current network status; wherein the creating a preloading task of the media file to be played based on the file header size includes: creating a preloading task of the media file to be played based on the file header size and the current network status.

Specifically, the media player may detect the current network status in real time; in the case where the network quality corresponding to the current network status is the best, that is, the current network is normal and there is a circumstance of network congestion, the size of the media file to be played required by the preloading task may be set to be smaller (for example, 800 KB), so as to ensure that a subsequent media file may be played in a second without lag by a smaller size of the media file to be played required to be loaded by the preloading task; in the case where the network quality corresponding to the current network status is the worst, that is, the current network is abnormal and there may be a circumstance of network outage, the size of the media file to be played required by the preloading task may be set to be larger (for example, 1200 KB), so as to ensure that a subsequent video may be played in a second without lag by a larger size of the media file required to be loaded by the preloading task.

All the above-described alternative technical solutions may form an alternative embodiment of the present disclosure by any combination, which will not be described in detail one by one. In addition, the size of the serial number of each step in the above-described embodiments does not mean the order of a performing sequence, and the order of performing each process should be determined according to its function and internal logic, and should not constitute any delimitation on the implementation process of the embodiment of the present disclosure.

FIG. 2 is a flowchart of another media file preloading method provided by one exemplary embodiment of the present disclosure. The media file preloading method of FIG. 2 may be performed by a media player. As shown in FIG. 2, the media file preloading method includes:
In S201, a media file playing request is sent to a media server, wherein the media file playing request carries a file identity of a media file to be played;
In S202, media information of the media file to be played corresponding to the file identity sent by the media server is received, wherein the media information includes a playback address and a file header size of the media file to be played;
In S203, a preloading task of the media file to be played is created based on the file header size, wherein the preloading task carries a preloading policy for indicating a preloading size and the start-to-play time of the preloaded media file to be played;
In S204, the file header data of the media file to be played is downloaded based on the playback address;
In S205, a file offset corresponding to the start-to-play time is obtained by parsing the file header data;
In S206, the media file to be played is preloaded from the file offset corresponding to the start-to-play time based on a preloading size.

According to the technical solution provided by the embodiment of the present disclosure, by preloading the file header data of the media file to be played based on the playback address, and preloading the media file to be played based on the file offset obtained by parsing the file header data, it is possible to achieve the effect of starting to play quickly at any start-to-play time in the case of preloading two segments of data, thereby improving the flexibility in playing the media file, avoiding a waste of performance and unnecessary consumption of traffic, and further enhancing the user experience.

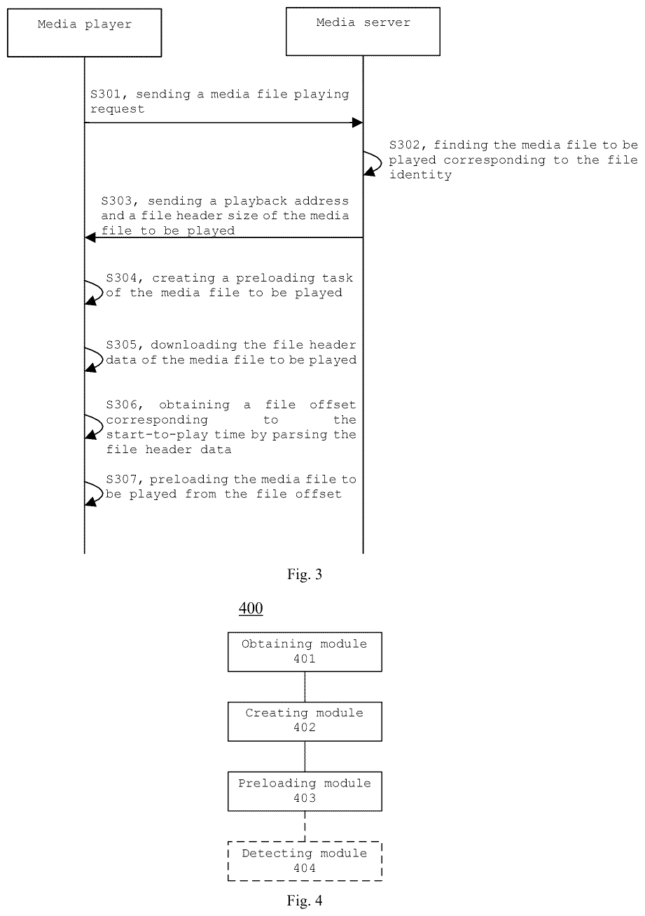

FIG. 3 is a flowchart of still another media file preloading method provided by one exemplary embodiment of the present disclosure. The interactive subjects involved in FIG. 3 are a media player and a media server. As shown in FIG. 3, the media file preloading method comprises:
In S301, the media player sends a media file playing request to the media server, wherein the media file playing request carries a file identity of a media file to be played;
In S302, the media server finds the media file to be played corresponding to the file identity in response to the media file playing request;
In S303, the media server sends a playback address and a file header size of the media file to be played to the media player;
In S304, the media player creates a preloading task of the media file to be played based on the file header size, wherein the preloading task carries a preloading policy for indicating the preloading size and the start-to-play time of the preloaded media file to be played;
In S305, the media player downloads the file header data of the media file to be played based on the playback address;
In S306, the media player obtain a file offset corresponding to the start-to-play time by parsing the file header data;
In S307, the media player preloads the media file to be played from the file offset corresponding to the start-to-play time based on the preloading size.

According to the technical solution provided by the embodiment of the present disclosure, by preloading the file header data of the media file to be played based on the playback address, and preloading the media file to be played based on the file offset obtained by parsing the file header data, it is possible to ensure that enough media data may be preloaded when the user starting to play the media file at any time, thereby improving the flexibility in playing the media file, avoiding a waste of performance and unnecessary consumption of traffic, and enhancing the user experience.

In the case where each functional module is divided according to each function, the embodiment of the present disclosure provides a media file preloading device, which may be a server or a chip applied to the server. FIG. 4 is a schematic structural view of a media file preloading device provided by one exemplary embodiment of the present disclosure. As shown in FIG. 4, the media file preloading device 400 comprises:
An obtaining module 401 configured to obtain media information of a media file to be played, wherein the media information includes a playback address and a file header size of the media file to be played;
A creating module 402 configured to create a preloading task of the media file to be played based on the file header size, wherein the preloading task carries a preloading policy for indicating a preloading size of the preloaded media file to be played; and
A preloading module 403 configured to obtain a file offset of the media file to be played based on the playback address, and preload the media file to be played based on the preloading size and the file offset.

According to the technical solution provided by the embodiment of the disclosure, it is possible to ensure that enough media data may be preloaded when the user starting to play a media file at any time, thereby improving the flexibility in playing the media file, avoiding a waste of performance and unnecessary consumption of traffic, and enhancing the user experience, by: obtaining media information of the media file to be played, wherein the media information includes a playback address and a file header size of the media file to be played; creating a preloading task of the media file to be played based on the file header size, wherein the preloading task carries a preloading policy for indicating a preloading size of the preloaded media file to be played; obtaining a file offset of the media file to be played based on the playback address, and preloading the media file to be played based on the preloading size and the file offset.

In some embodiments, the obtaining module 401 of FIG. 4 sends a media file playing request to the media server, wherein the media file playing request carries a file identity of the media file to be played; and receives media information of the media file to be played corresponding to the file identity sent by the media server.

In some embodiments, the preloading policy is also used to indicate the start-to-play time of preloading the media file to be played; the preloading module 403 of FIG. 4 downloads the file header data of the media file to be played based on the playback address; and analyzes the file header data to obtain the file offset corresponding to the start-to-play time.

In some embodiments, the preloading module 403 of FIG. 4 preloads the media file to be played from the file offset corresponding to the start-to-play time based on a preloading size.

In some embodiments, the preloading module 403 of FIG. 4 preloads the media file to be played from the file offset corresponding to the first time based on the preloading size in the case where the start-to-play time is between the first time and the second time, wherein the first time is earlier than the second time.

In some embodiments, the media file preloading device 400 of FIG. 4 further includes a detecting module 404 configured to detect a current network status, wherein the creating module 402 of FIG. 4 creates a preloading task of the media file to be played based on the file header size and the current network status.

In some embodiment, the media file is played in a non-streaming media format.

The implementation process of the functions and effects of each module in the above-described device is specifically seen in the implementation process of corresponding steps in the above-described method in detail, which will not be described in detail here.

An embodiment of the present disclosure also provides an electronic device, which comprises: at least one processor; a memory for storing instructions executable by the at least one processor; wherein the at least one processor is configured to execute the instructions to realize the steps of the above-described media file preloading method disclosed in the embodiment of the present disclosure.

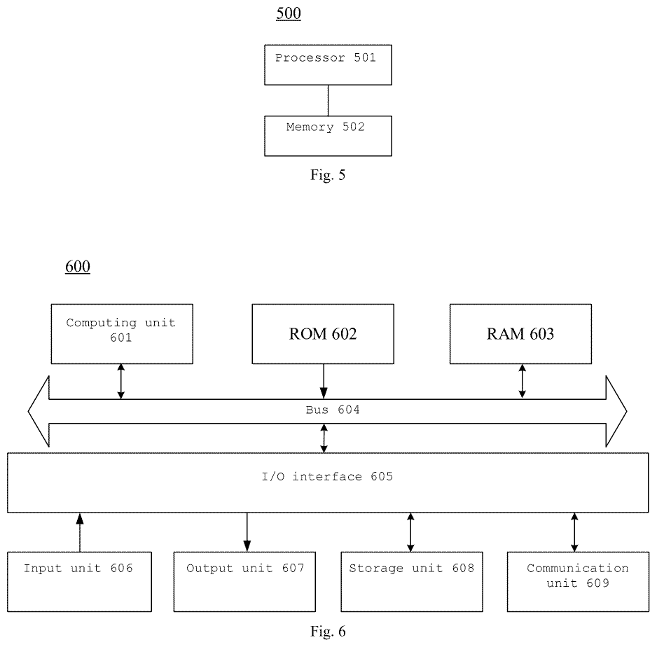

FIG. 5 is a schematic structural view of an electronic device provided by one exemplary embodiment of the present disclosure. As shown in FIG. 5, the electronic device 500 includes at least one processor 501 and a memory 502 coupled to the processor 501, and the processor 501 may perform corresponding steps in the above-described method disclosed in the embodiment of the present disclosure.

The above-described processor 501 which may also be referred to as a Central Processing Unit (CPU), may be an integrated circuit chip with signal processing capability. Various steps in the above-described method disclosed in the embodiment of the present disclosure may be completed by an integrated logic circuit of hardware or an instruction in the form of software in the processor 501. The above-described processor 501 may be a general processor, a Digital Signal Processing (DSP), an Application Specific Integrated Circuit (ASIC), a Field-programmable Gate Array (FPGA) or other programmable logic devices, discrete gate or transistor logic devices, and discrete hardware assemblies. The general purpose processor may be a microprocessor, or the processor may also be any conventional processor or the like. The steps of the above-described method disclosed in combination with the embodiment of the present disclosure may be directly embodied as being performed and completed by a hardware decoding processor, or as being performed and completed by a combination of hardware and software modules in the decoding processor. The software modules may be located in the memory 502, for example, a random memory, a flash memory, a read-only memory, a programmable read-only memory or an electrically erasable programmable memory, a register and other common storage media in this field. The processor 501 reads the information in the memory 502 and completes the steps of the above-described method in combination with its hardware.

In addition, in the case where various operations/processes according to the present disclosure are implemented by software and/or firmware, it is possible to install a program constituting the software to a computer system with a dedicated hardware structure, for example, the computer system 600 shown in FIG. 6, from a storage medium or a network; when the computer system is installed with various programs, it is possible to perform various functions, including the functions described previously. FIG. 6 is a schematic structural view of a computer system provided by one exemplary embodiment of the present disclosure.

The computer system 600 is intended to represent various forms of digital electronic computer devices, such as a laptop computer, a desktop computer, a workstation, a personal digital assistant, a server, a blade server, a mainframe computer, and other suitable computers. The electronic device may also represent various forms of mobile devices, such as personal digital processing, a cellular phone, a smart phone, a wearable device and other similar computing devices. The components shown herein, their connections and relationships as well as their functions are only exemplary, and not intended to limit the implementation of the present disclosure described and/or claimed herein.

As shown in FIG. 6, the computer system 600 includes a computing unit 601, which may perform various appropriate actions and processes according to a computer program stored in the read-only memory (ROM) 602 or a computer program loaded from the storage unit 608 into the random access memory (RAM) 603. In the RAM 603, various programs and data required for the operation of the computer system 600 may also be stored. The computing unit 601, the ROM 602 and the RAM 603 are connected to each other via a bus 604. The input/output (I/O) interface 605 is also connected to the bus 604.

A plurality of components in the computer system 600 are connected to the I/O interface 605, which include an input unit 606, an output unit 607, a storage unit 608 and a communication unit 609. The input unit 606 may be any type of device that may input the information to the computer system 600, and the input unit 606 may receive the input numeric or character information and generate key signal input related to user setting and/or function control of the electronic device. The output unit 607 may be any type of device capable of presenting information, and may include but is not limited to a display, a speaker, a video/audio output terminal, a vibrator and/or a printer. The storage unit 608 may include, but is not limited to, a magnetic disk and an optical disk. The communication unit 609 allows the computer system 600 to exchange information/data with other devices through a network such as Internet, and may include but is not limited to a modem, a network card, an infrared communication device, a wireless communication transceiver and/or a chipset, such as a Bluetooth™M device, a WiFi device, a WiMax device, a cellular communication device and/or the like.

The computing unit 601 may be various general and/or special processing components with processing and computing capabilities. Some examples of the computing unit 601 include, but are not limited to, a central processing unit (CPU), a graphics processing unit (GPU), various specialized artificial intelligence (AI) computing chips, various computing units running a machine learning model algorithm, a digital signal processor (DSP), and any suitable processor, controller, microcontroller and the like. The computing unit 601 performs various methods and processes described above. For example, in some embodiments, the above-described method disclosed in an embodiment of the present disclosure may be implemented as a computer software program, which is tangibly embodied in a machine-readable medium, for example, the storage unit 608. In some embodiments, some or all of the computer programs may be loaded and/or installed on the electronic device 600 via the ROM 602 and/or the communication unit 609. In some embodiments, the computing unit 601 may be configured to perform the above-described method disclosed in the embodiment of the present disclosure through any other suitable means (for example, by means of firmware).

The embodiment of the present disclosure also provides a computer-readable storage medium, wherein the instructions in the computer-readable storage medium, when executed by a processor of an electronic device, cause the electronic device to perform the above-described method disclosed in the embodiment of the present disclosure.

The computer-readable storage medium in the embodiment of the present disclosure may be a tangible medium, which may contain or store a program for use by the instruction execution system, apparatus, or device or use in combination with the instruction execution system, apparatus, or device. The computer-readable storage medium may include, but is not limited to, an electronic, magnetic, optical, electromagnetic, infrared, or semiconductor system, apparatus or device, or any suitable combination thereof. More specifically, the above-described computer-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The above-described computer-readable medium may be included in the above-described electronic device; or may also exist alone without being assembled into the electronic device.

The embodiments of the present disclosure further provide a computer program product including a computer program, wherein the computer program, when executed by a processor, implements the above-described method disclosed in the embodiment of the present disclosure.

In the embodiment of the present disclosure, the computer program code for performing the operations of the present disclosure may be written in one or more programming languages or a combination thereof; the above-described programming languages include but are not limited to object-oriented programming languages, such as Java, Smalltalk, and C++, and also include conventional procedural programming languages, such as “C” language or similar programming languages. The program code may be executed entirely on the user's computer, partly on the user's computer, executed as an independent software package, partly on the user's computer and partly executed on a remote computer, or entirely executed on the remote computer or server. In the instance involving a remote computer, the remote computer may be connected to the user's computer through any type of network (including a local area network (LAN) or a wide area network (WAN)), or may be connected to an external computer.

The flowcharts and block views in the accompanying drawings illustrate the possibly implemented architectures, functions, and operations of the system, method, and computer program product according to various embodiments of the present disclosure. In this regard, each block in the flowchart or block view may represent a module, a program segment, or a part of code, wherein the module, the program segment, or the part of code contains one or more executable instructions for realizing a specified logic function. It should also be noted that, in some alternative implementations, the functions marked in the block may also occur in a different order from the order marked in the accompanying drawings. For example, two blocks shown in succession which may actually be executed substantially in parallel, may sometimes also be executed in a reverse order, depending on the functions involved. It is also to be noted that each block in the block view and/or flowchart, and a combination of the blocks in the block view and/or flowchart, may be implemented by a dedicated hardware-based system that performs the specified functions or operations, or may be implemented by a combination of dedicated hardware and computer instructions.

The modules, components, or units involved in the described embodiments of the present disclosure may be implemented in software or hardware. Wherein, the names of the modules, components or units do not constitute a limitation on the modules, components or units themselves under certain circumstances.

The functions described hereinabove may be performed at least in part by one or more hardware logic components. For example, without limitation, the exemplary hardware logic components that may be used include: a Field Programmable Gate Array (FPGA), an Application Specific Integrated Circuit (ASIC), an Application Specific Standard Product (ASSP), a System on Chip (SOC), a Complex Programmable Logical device (CPLD) and the like.

The above description is only an explanation of some embodiments of the present disclosure and the applied technical principles. Those skilled in the art should understand that the scope of disclosure involved in the present disclosure is not limited to the technical solutions formed by the specific combination of the above technical features, and at the same time should also cover other technical solutions formed by arbitrarily combining the above-described technical features or equivalent features without departing from the above disclosed concept. For example, a technical solution formed by the above-described features and the technical features disclosed in the present disclosure (but not limited thereto) having similar functions replacing with each other.

Although some specific embodiments of the present disclosure have been described in detail by way of examples, those skilled in the art should understand that the above examples are only for an illustrative purpose, rather than limiting the scope of the present disclosure. Those skilled in the art should appreciate that modifications to the above embodiments may be made without departing from the scope and spirit of the present disclosure. The scope of the present disclosure is defined by the appended claims.

1. A media file preloading method applied to a media player, the method comprising:
obtaining media information of a media file to be played, wherein the media information comprises a playback address and a file header size of the media file to be played;
creating a preloading task of the media file to be played based on the file header size, wherein the preloading task carries a preloading policy for indicating a preloading size of the media file to be played; and
obtaining a file offset of the media file to be played based on the playback address, and preloading the media file to be played based on the preloading size and the file offset.

2. The method according to claim 1, wherein the obtaining media information of the media file to be played comprises:
sending a media file playing request to a media server, wherein the media file playing request carries a file identity of the media file to be played; and
receiving the media information of the media file to be played corresponding to the file identity sent by the media server.

3. The method according to claim 1, wherein the preloading policy is further used to indicate the start-to-play time of preloading the media file to be played, and the obtaining the file offset of the media file to be played based on the playback address comprises:
downloading the file header data of the media file to be played based on the playback address; and
parsing the file header data to obtain the file offset corresponding to the start-to-play time.

4. The method according to claim 3, wherein the preloading the media file to be played based on the preloading size and the file offset comprises:
preloading the media file to be played from the file offset corresponding to the start-to-play time based on the preloading size.

5. The method according to claim 4, wherein the preloading the media file to be played from the file offset corresponding to the start-to-play time based on the preloading size comprises:
preloading the media file to be played from the file offset corresponding to a first time based on the preloading size in the case where the start-to-play time is between the first time and a second time, wherein the first time is earlier than the second time.

6. The method according to claim 1, wherein the method further comprises:
detecting a current network status;
wherein the creating the preloading task of the media file to be played based on the file header size comprises:
creating the preloading task of the media file to be played based on the file header size and the current network status.

7. The method according to claim 1, wherein the media file to be played is in a non-streaming format.

8. (canceled)

9. An electronic device, comprising:
at least one processor;
at least one memory for storing instructions executable by the at least one processor;
wherein the at least one processor is configured to execute the instructions to implement a media file preloading method applied to a media player, the method comprising:
obtaining media information of a media file to be played, wherein the media information comprises a playback address and a file header size of the media file to be played;
creating a preloading task of the media file to be played based on the file header size, wherein the preloading task carries a preloading policy for indicating a preloading size of the media file to be played; and
obtaining a file offset of the media file to be played based on the playback address, and preloading the media file to be played based on the preloading size and the file offset.

10. A non-transitory computer-readable storage medium, wherein instructions in the computer-readable storage medium, when executed by a processor of an electronic device, cause the electronic device to perform a media file preloading method applied to a media player, the method comprising:
obtaining media information of a media file to be played, wherein the media information comprises a playback address and a file header size of the media file to be played;
creating a preloading task of the media file to be played based on the file header size, wherein the preloading task carries a preloading policy for indicating a preloading size of the media file to be played; and
obtaining a file offset of the media file to be played based on the playback address, and preloading the media file to be played based on the preloading size and the file offset.

11. (canceled)

12. (canceled)

13. The electronic device according to claim 9, wherein the obtaining media information of the media file to be played comprises:
sending a media file playing request to a media server, wherein the media file playing request carries a file identity of the media file to be played; and
receiving the media information of the media file to be played corresponding to the file identity sent by the media server.

14. The electronic device according to claim 9, wherein the preloading policy is further used to indicate the start-to-play time of preloading the media file to be played, and the obtaining the file offset of the media file to be played based on the playback address comprises:
downloading the file header data of the media file to be played based on the playback address; and
parsing the file header data to obtain the file offset corresponding to the start-to-play time.

15. The electronic device according to claim 14, wherein the preloading the media file to be played based on the preloading size and the file offset comprises:
preloading the media file to be played from the file offset corresponding to the start-to-play time based on the preloading size.

16. The electronic device according to claim 15, wherein the preloading the media file to be played from the file offset corresponding to the start-to-play time based on the preloading size comprises:
preloading the media file to be played from the file offset corresponding to a first time based on the preloading size in the case where the start-to-play time is between the first time and a second time, wherein the first time is earlier than the second time.

17. The electronic device according to claim 9, wherein the method further comprises:
detecting a current network status;
wherein the creating the preloading task of the media file to be played based on the file header size comprises:
creating the preloading task of the media file to be played based on the file header size and the current network status.

18. The electronic device according to claim 9, wherein the media file to be played is in a non-streaming format.

19. The non-transitory computer-readable storage medium according to claim 10, wherein the obtaining media information of the media file to be played comprises:
sending a media file playing request to a media server, wherein the media file playing request carries a file identity of the media file to be played; and
receiving the media information of the media file to be played corresponding to the file identity sent by the media server.

20. The non-transitory computer-readable storage medium according to claim 10, wherein the preloading policy is further used to indicate the start-to-play time of preloading the media file to be played, and the obtaining the file offset of the media file to be played based on the playback address comprises:
downloading the file header data of the media file to be played based on the playback address; and
parsing the file header data to obtain the file offset corresponding to the start-to-play time.

21. The non-transitory computer-readable storage medium according to claim 20, wherein the preloading the media file to be played based on the preloading size and the file offset comprises:
preloading the media file to be played from the file offset corresponding to the start-to-play time based on the preloading size.

22. The non-transitory computer-readable storage medium according to claim 21, wherein the preloading the media file to be played from the file offset corresponding to the start-to-play time based on the preloading size comprises:
preloading the media file to be played from the file offset corresponding to a first time based on the preloading size in the case where the start-to-play time is between the first time and a second time, wherein the first time is earlier than the second time.

23. The non-transitory computer-readable storage medium according to claim 10, wherein the method further comprises:
detecting a current network status;
wherein the creating the preloading task of the media file to be played based on the file header size comprises:
creating the preloading task of the media file to be played based on the file header size and the current
